(19) United States
(12) Patent Application Publication
(10) Pub. No.: US 2009/0119276 A1
(43) Pub. Date: May 7, 2009

(54) Method and Internet-based Search Engine System for Storing, Sorting, and Displaying Search Results

(76) Inventor: Antoine Sorel Neron, Chicago, IL (US)

Correspondence Address: WHITE-WELKER & WELKER, LLC, P.O. BOX 199, CLEAR SPRING, MD, 21722-0199, US

(21) Appl. No.: 11/934,025

(22) Filed: Nov. 1, 2007

(51) Int. Cl. G06F 17/30

(52) U.S. Cl. 707/5; 707/E17.017

(57) ABSTRACT

A method and Internet-based search engine system for storing, sorting, and displaying search results. In a first step, a search is performed by keywords and will return results that are sorted by keyword score per result. In a second step, when a user clicks on a search result the system displays the subsequent page. In a third and final step, the viewing of the subsequent page may add to the results keyword score resulting in an increase in that listing's score for that particular keyword, depending upon how long the user views it for. The system also determines how long the user is viewing the subsequent page. The keyword score is determined by a result/listing's ability to engage the user who clicked on it. There are two types of sub-scores that determine the keyword score for the listing; the ‘7-score’; and the ‘15-score’.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to search engines. More specifically the present invention relates to a method and Internet-based search engine system for storing, sorting, and displaying search results.

### BACKGROUND OF THE INVENTION

The present invention is a method and Internet-based search engine system for storing, sorting, and displaying search results. Many related Internet-based search engines are known and the prior art, but each has shortcomings over which the present invention improves.

U.S. Pat. No. 6,845,372 teaches a method and computer program product are provided for implementing search engine operational modes. A search request is received from a user. Responsive to the search request, an impatient score for the user is determined. Responsive to the impatient score, a search engine operational mode is adjusted for implementing the search request. Multiple factors are evaluated to determine the impatient score for the user. These factors include selected ones of the following: the search words in the search request; presence of predefined control words in the search request; presence of predefined impatient words in the search request; a number of searches by the user during a search session; a time between searches; user connection speed; and user entry selections. Responsive to the impatient score, the search engine operational mode is adjusted by identifying the impatient score within a first define range and performing synonym augmentation of the search request.

U.S. Pat. No. 6,336,112 teaches a method for cataloging, filtering and ranking information, as for example, World Wide Web pages of the Internet. The method is preferably implemented in computer software and features steps for enabling a user to interactively create an information database including preferred information elements such as preferred-authority World Wide Web pages. The method includes steps for enabling a user to interactively create a frame-based, hierarchical organizational structure for the information elements, and steps for identifying and automatically filtering and ranking by relevance, information elements, such as World Wide Web pages for populating the structure, to form, for example, a searchable, World Wide Web page database. Additionally, the method features steps for enabling a user to interactively define a frame-based, hierarchical information structure for cataloging information, identifying a preliminary population of information elements for a particular hierarchical category.

U.S. Pat. No. 6,734,886 teaches a method of customizing the browsing experience of a user of a Web site comprised of a plurality of Web pages is provided. Each Web page is indexed using at least one coding system. A user record for each user is maintained on the Web site, which contains personal information of the user coded in accordance with said coding system. The user's browsing experience on the site may thus be readily customized using the user's personal information via code comparison. In accordance with a second aspect of the present invention, a method of ensuring the privacy of the user's personal information is provided through use of a unique Universal Anonymous Identifier (UAI) assigned to each user by a third party registration authority.

U.S. Pat. No. 6,334,131 teaches a method for cataloging, filtering and ranking information, as for example, World Wide Web pages of the Internet. The method is preferably implemented in computer software and features steps for enabling a user to interactively create an information database including preferred information elements such as preferred-authority World Wide Web pages. The method includes steps for enabling a user to interactively create a frame-based, hierarchical organizational structure for the information elements, and steps for identifying and automatically filtering and ranking by relevance, information elements, such as World Wide Web pages for populating the structure, to form, for example, a searchable, World Wide Web page database. Additionally, the method features steps for enabling a user to interactively define a frame-based, hierarchical information structure for cataloging information, identifying a preliminary population of information elements for a particular hierarchical category.

U.S. Pat. No. 5,737,734 teaches a method for performing a search of a database in an information retrieval system in response to a query having at least one query word with a query word weight and for applying the query word to the database and selecting information from the information retrieval system in accordance with the query word. A query word is selected and assigned a weight. The weight is adjusted depending on whether the query word is a proper noun or slow word. The adjusting can be an increase or a decrease in the weight. Information is selected from the information retrieval system in accordance with the adjusted weight.

U.S. Pat. No. 6,963,867 teaches a search engine system displays the results of a multiple-category search according to levels of relevance of the categories to a user's search query. A query server receives a search query from a user and identifies, within each of multiple item categories, a set of items that satisfy the query. The sets of items are used to generate, for each of the multiple categories, a score that reflects a level significance or relevance of the category to the search. The scores may be based, for example, on the number of hits within each category relative to the total number of items in that category, the popularity levels of items that satisfy the query, a personal profile of the user, or a combination thereof. The categories are then presented to the user, together with the most relevant items within each category, in the order of highest to lowest category relevance.

U.S. Pat. No. 7,003,513 teaches a method and a system for re-ranking an existing result set of documents. A user starts a search by entering search term(s). The search term(s) is (are) transferred to a search engine which generates a result set ranked by the search term(s). The search engine, in parallel, automatically retrieves context information from returned result set which is related to the original set of documents. The search engine presents the context information to the user and asks for a feedback. The user performs a weighting of the presented context information in a range from “important” to “non-important”. The result set is then re-ranked with the user-weighted context information to increase the “rank distance” of important and non important documents. The documents that are on top of the list (highest context-weighted ranking value) represent the desired information.

U.S. Pat. No. 6,714,929 teaches a search engine for databases, data streams, and other data sources allows user preferences as to the relative importance of search criteria to be used to rank the output of the search engine. A weighted preference generator generates weighted preference information including at least a plurality of weights corresponding to a plurality of search criteria. A weighted preference data search engines uses the weighted preference information to search a data source and to provide an ordered result list based upon the weighted preference information. A method for weighted preference data searching includes determining weighted preference information including a plurality of search criteria and a corresponding plurality of weights signifying the relative importance of the search criteria, and querying a data source and ranking the results based upon the weighted preference information. In addition to allowing client input of the relative importance of various search criteria.

Therefore it is an objective of the present invention to a method and Internet-based search engine system for storing, sorting, and displaying search results wherein search is performed by keywords and will return results that are sorted by keyword score (“KS”) per result.

It is another objective of the present invention to teach a search engine system where a user clicks on a search result the system displays the subsequent page and the viewing of the subsequent page may add to the results keyword score resulting in an increase in that listing's score for that particular keyword, depending upon how long the user views it for.

It is yet another objective of the present invention to teach a system that is also able to determine how long the user is viewing a subsequent page.

Still another objective is to teach a means for accurate scoring, the system taught by the present invention is able to identify when a user clicks into and out-of the browser widget within the system. The system will also determine if a user is actively viewing the listing or is in another browser window or tab, in order that the proper score may be determined.

### SUMMARY OF THE INVENTION

The present invention is a method and Internet-based search engine system for storing, sorting, and displaying search results. In a first step, a search is performed by keywords and will return results that are sorted by keyword score (“KS”) per result. In a second step, when a user clicks on a search result the system displays the subsequent page. In a third and final step, the viewing of the subsequent page may add to the results keyword score resulting in an increase in that listing's score for that particular keyword, depending upon how long the user views it for. The system is also able to determine how long the user is viewing the subsequent page.

The keyword score is determined by a result/listing's ability to engage the user who clicked on it. There are two types of sub-scores that determine the keyword score for the listing. The first sub-score is the ‘7-score’. A listing will increase its ‘7-score’ for the keyword when a user views the listing for more than seven seconds. The second sub-score is the ‘15-score’. A listing will increase its ‘15-score’ for the keyword when a user views the listing for more than fifteen seconds. The ‘15-score’ is never more than the ‘7-score’ for a listing's keyword, as a user who views a listing for fifteen seconds has increased both the ‘7-score’ and ‘15-score’ for the listing. To determine the keyword score we have the following formula: KS=‘15-score’/‘7-score’. The keyword score has a value of seven decimal places.

For accurate scoring, the system is able to identify when a user clicks into and out-of the browser widget within the system. It also will be determined if a user is actively viewing the listing or is in another browser window or tab, in order that the proper score may be determined.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the method used by the internet-based search engine for storing, sorting, and displaying search results;

FIG. 2 is a flow chart illustrating stimulus and response sequences for a search are performed by keywords and return results that are sorted by keyword score on a per result basis; and

FIG. 3 is a flow chart illustrating the method of attaching a keyword score to a search result in a first function of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

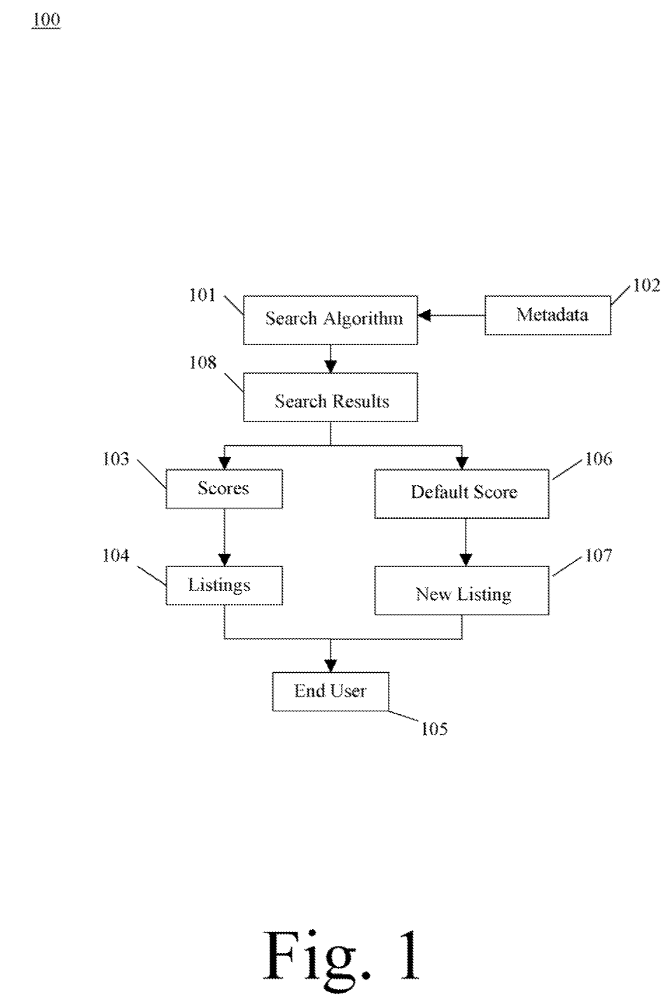

Now referring to FIG. 1, a description of a method to be used by the internet-based search engine for storing, sorting, and displaying search results of the present invention 100 is illustrated. The present invention utilizes a search algorithm 101 using listing metadata 102 to determine scores 103 for listings 104. These scores 103 affect the order in which listings 104 are displayed to the end user 105, as well as the default score 106 for any new listing 107 in the search results 108.

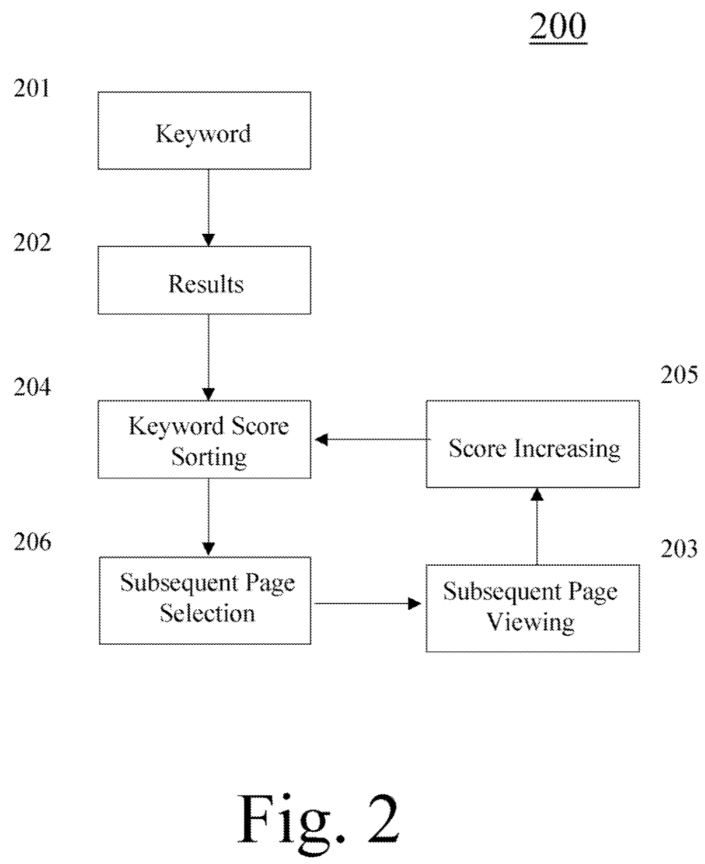

Now referring to FIG. 2, stimulus and response sequences 200 for a search are performed by keywords 201 and return results 202 that are sorted 203 by keyword score (“KS”) 204 on a per result basis. When a user clicks on a search result 202, the system displays the subsequent page 205. The viewing 203 of the subsequent page 206 may add to the results keyword score 204 thereby increase that listing's score 205 for that particular keyword 201, depending upon how long the user views it for. It is important to note that the system is able to determine how long the user is viewing the subsequent page 206.

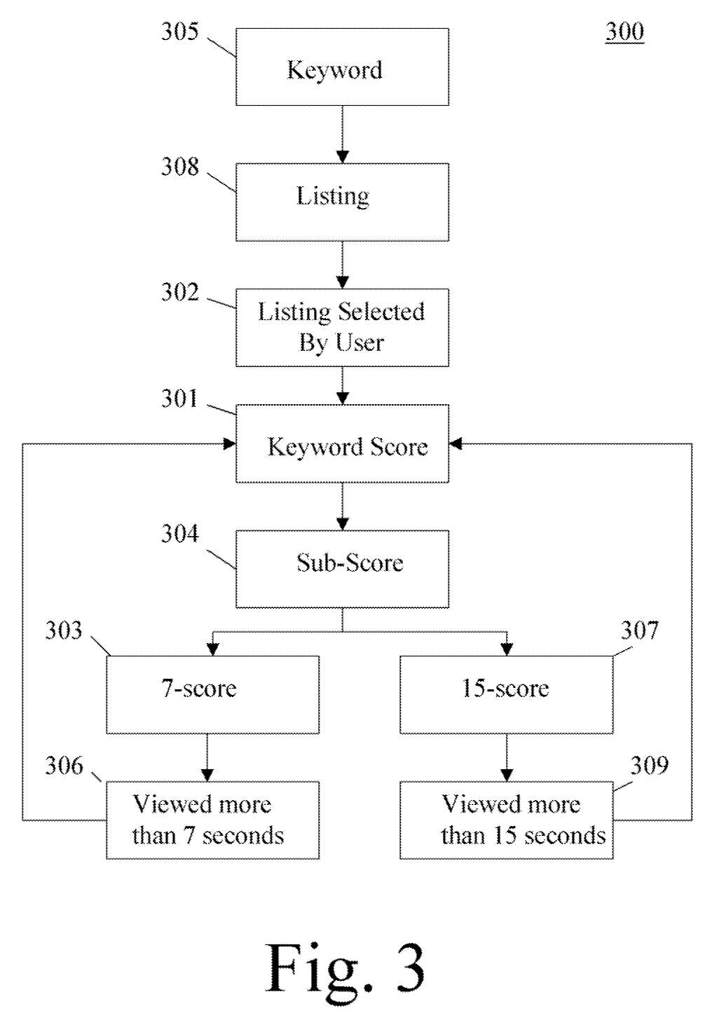

The method of attaching a keyword score to a search result 300 is the first function of the present invention is shown in FIG. 3. A keyword score 301 is determined by a result/listing's ability to engage the user who clicked on it 302. There are two types of sub-scores 304 that determine the keyword score 31 for the listing. The first sub-score is the ‘7-score’ 303. A listing 308 will increase its ‘7-score’ 303 for the keyword 305 when a user views the listing for more than seven seconds 306. The second sub-score is the ‘15-score’ 307. A listing 308 will increase its ‘15-score’ 307 for the keyword 305 when a user views the listing 308 for more than fifteen seconds 309. The ‘15-score’ 307 is never more than the ‘7-score’ 303 for a listing's keyword 305, as a user who views a listing for fifteen seconds has increased both the ‘7-score’ 303 and ‘15-score’ 307 for the listing. To determine the keyword score the following formula: KS=‘15-score’/‘7-score’ is used. The keyword score 301 has a value of seven decimal places.

For accurate scoring, the system is able to identify when a user clicks into and out-of the browser within the system. It also will be determined if a user is actively viewing the listing or is in another browser window or tab, in order that the proper score may be determined.

In the following example we look at the first three of a users ten keywords and corresponding KS for the users listing for an, “Aston Martin DB7 VANTAGE”

TABLE 1
Keywords and corresponding KS for a listing.

| Keyword | 7-score points | 15-score points | KS |
|---|---|---|---|
| Vantage | 13 | 6 | 0.4615385 |
| Aston Martin | 9 | 3 | 0.3333333 |
| Db7 | 12 | 48 | 0.1538462 |

In this example, as shown in Table 1, it is illustrated that thirteen users who searched for ‘vantage’ viewed the user's listing for at least seven seconds. However, only six of those visitors viewed it for at least fifteen seconds. For the KS, the number of visitors to a listing is irrelevant. The only factor in determining relevancy of a listing to a keyword is the KS, derived by the above formula. Thus, a user typing in ‘aston martin vantage’ will see the search results displayed in the order shown in Table 2.

TABLE 2
Search Results Display.

| | | | KS for |
|---|---|---|---|
| Position | Title | Seller | Keyword* |
| 1 | Aston Martin DB7 VANTAGE | Bob | 0.4615385 |
| 2 | Aston Martin:DB7 Volante | Autosales | 0.2941176 |
| 3 | Aston Martin DB9 Coupe | Happycars | 0.1538462 |
| 4 | Aston Martin DB9 5.9L V12 | Davidsons | 0.0928726 |
| 5 | Aston Martin DB9 CABRIO | Markys112 | 0.0705882 |
| 7 | Aston Martin | Titan | 0.0154100 |

Listing viewing times under seven seconds per do not affect the listing's keyword score. Additionally, only the last four hundred viewings of a listing are used to calculate its KS. If the listing is deleted (by the user or the system) the keyword scores attached to the listing are also deleted.

For accurate scoring, the system will be able to identify user actions when a user clicks into and out-of the browser widget within the system. The system will also determine if a user is actively viewing the listing or is in another browser window or tab, in order that the proper score may be determined.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A Method and Internet-based Search Engine System for Storing, Sorting, and Displaying Search Results comprising:
executing a search;
returning a search result query of search results;
attaching a keyword score to a search result; and
determining a keyword score based on a listing's ability to engage the user who clicked on it in a time based measurement.

2. The Method and Internet-based Search Engine System for Storing, Sorting, and Displaying Search Results of claim 1 further utilizing a search algorithm using listing metadata to determine scores for listings.

3. The Method and Internet-based Search Engine System for Storing, Sorting, and Displaying Search Results of claim 1 wherein the act of attaching a keyword score to a search result is further comprised of two or more types of sub-scores determine the keyword score for the listing.

4. The Method and Internet-based Search Engine System for Storing, Sorting, and Displaying Search Results of claim 3 wherein
a first sub-score is determined for the keyword when a user views the listing for a first pre-determined period of time; and
a second sub-score is determined for the keyword when a user views the listing for a pre-determined period of time.

5. The Method and Internet-based Search Engine System for Storing, Sorting, and Displaying Search Results of claim 4 wherein
the first sub-score is determined when a listing increases its score for the keyword when a user views the listing for more than seven seconds; and
the second sub-score is determined when a listing increases its score for the keyword when a user views the listing for more than fifteen seconds.

6. The Method and Internet-based Search Engine System for Storing, Sorting, and Displaying Search Results of claim 4 wherein the second pre-determined period of time is longer in duration that the first pre-determined period of time.

7. The Method and Internet-based Search Engine System for Storing, Sorting, and Displaying Search Results of claim 4 wherein the first sub-score and second sub-score affect the order in which listings are displayed to the end user, as well as the default score for any new listings in the search results.

8. The Method and Internet-based Search Engine System for Storing, Sorting, and Displaying Search Results of claim 4 wherein to determine the keyword score the following formula is used: keyword score equals first sub-score divided by the second sub-score is used.

9. The Method and Internet-based Search Engine System for Storing, Sorting, and Displaying Search Results of claim 8 wherein the keyword score has a value of seven decimal places.

10. The Method and Internet-based Search Engine System for Storing, Sorting, and Displaying Search Results of claim 8 wherein stimulus and response sequences for a keyword search are performed by keywords and return results that are sorted by keyword score on a per result basis.

11. The Method and Internet-based Search Engine System for Storing, Sorting, and Displaying Search Results of claim 10 wherein
when a user clicks on a search result, the system displays a subsequent page;
the viewing of the subsequent page adds to the results keyword score thereby increases that listing's score for that particular keyword, depending upon how long the user views it.

12. The Method and Internet-based Search Engine System for Storing, Sorting, and Displaying Search Results of claim 11 wherein the system is able to determine how long the user is viewing the subsequent page.

13. The Method and Internet-based Search Engine System for Storing, Sorting, and Displaying Search Results of claim 11 the system is able to identify when a user clicks into and out-of a browser within the system.

14. The Method and Internet-based Search Engine System for Storing, Sorting, and Displaying Search Results of claim 11 the system is able to identify if a user is actively viewing the listing or is in another browser window or tab, in order that the proper score may be determined.

15. The Method and Internet-based Search Engine System for Storing, Sorting, and Displaying Search Results of claim 5 wherein listing viewing times under seven seconds per do not affect the listing's keyword score.

16. The Method and Internet-based Search Engine System for Storing, Sorting, and Displaying Search Results of claim 5 wherein only the last four hundred viewings of a listing are used to calculate its keyword score.

17. The Method and Internet-based Search Engine System for Storing, Sorting, and Displaying Search Results of claim 5 wherein when the listing is deleted by the user or the system, the keyword scores attached to the listing are also deleted.
